(19) United States
(12) Patent Application Publication
(10) Pub. No.: US 2012/0124740 A1
(43) Pub. Date: May 24, 2012

(54) MAT

(76) Inventor: Kerstin Castle, Cambridgeshire (GB)

(21) Appl. No.: 13/302,856

(22) Filed: Nov. 22, 2011

(30) Foreign Application Priority Data
Nov. 24, 2010 (GB) 1019880.2

(51) Int. Cl. A47G 9/06; B32B 7/04; A47D 13/00

(52) U.S. Cl. 5/420; 156/91

(57) ABSTRACT

The present invention relates to mats, and in particular, to floor play mats for babies and children. The invention extends to uses of the play mat, and to methods of manufacturing such mats.

This application makes a claim of priority under 35 USC §119(a) to United Kingdom patent application No. 1019880.2, filed Nov. 24, 2010, currently pending.

The present invention relates to mats, and in particular, floor play mats for babies and children. The invention extends to uses of the play mat, and to methods of manufacturing such mats.

Babies undergo rapid physical and mental development, especially during the first year of their lives. Between the age of about two and ten months, babies develop motor skills, which begin with them being unable to hold their head unsupported, to being able to sit up unaided and crawling. This development requires the baby to exercise its newly developing muscles and to learn how to coordinate their movements, usually while lying on a flat surface.

Child experts advocate nurturing, healthy and safe environments, and it is well-known that physical contact with an adult is critical for a baby's development. Yet, surprisingly, while there are many child products which entertain and stimulate a small baby (e.g. activity centres with music, flashing lights etc.), no floor play mats exist which allow a comfortable environment for baby and parent activities, such as looking at books, stacking cups or bricks, singing, tickling, etc., which would promote bonding between the baby and parent (or carer) and allow the baby to practise new motor and communication skills

Child experts recommend that the parent should place the baby on its tummy for short periods of time as soon as the baby is able to support its head. To this end, babies are often placed in beds, or on sofas, because such surfaces are soft, and therefore comfortable for the baby. However, as soon as the baby gains the ability to roll over, it is in danger of falling off elevated surfaces. A safer alternative is to place the baby on the floor, so that it cannot injure itself when it wriggles and rolls. However, placing a baby on the floor has its own disadvantages, because floors are rarely entirely clean, leaving the baby in danger of ingesting dust, dirt, pet hair, human hair, etc. Furthermore, floors are often neither soft nor warm enough to constitute an ideal surface for babies to lie on. Hence, traditionally, blankets or rugs have been used to provide insulation and cushioning for babies placed on the floor.

Baby activity mats are a more modern version of the blanket, and are purposely designed to entertain small babies often with overhead activities. Such activity mats consist of a padded floor pad and, in most cases, provide stimulation for the infant, such as crinkle material, mirrors or squeakers, which are integrated into the mat. However, these activity mats suffer from several disadvantages. Firstly, they are usually only big enough to accommodate a baby, and so the parent has to sit on the floor outside of the mat. Secondly, the padding is basic and does not provide significant cushioning if placed on a hard floor, and so is uncomfortable for the child. Thirdly, activity mats, due to their complex design and the integrated toys, are often not machine washable, which is inconvenient as young babies frequently dribble and vomit. Fourthly, padded blankets can fold over, which means they can be pulled over a baby's face, possibly causing anxiety and pose a suffocation risk.

Another alternative to blankets, rugs or other woven materials, are foam jigsaw mats made from solid ethylene vinyl acetate (EVA) foam. This type of floor covering provides good insulating properties and can extended to any size desired by virtue of its jigsaw nature. However, as it is made from solid foam, it provides insufficient cushioning, and is therefore uncomfortable for a small baby. In addition, dribbles and vomit from the baby tend to leak in between the interconnecting jigsaw pieces, and the undulating surface of the EVA foam attracts and traps dirt, and so the mat is unhygienic. This type of mat therefore also does not constitute an ideal surface for babies to play on.

Because of the numerous shortcomings of currently available play mats for infants, it is desirable to provide an alternative mat, which provides a comfortable, safe and hygienic surface for both babies and their carers to lie and play on simultaneously.

According to a first aspect, there is provided a child's play mat comprising:
(i) a first layer comprising an impermeable material;
(ii) a second layer disposed adjacent the first layer, and comprising polyurethane memory foam;
(iii) a third layer disposed adjacent the second layer, and comprising an impermeable material; and
(iv) a fourth layer disposed adjacent the third layer, and comprising a material capable of absorbing liquid, and wicking the liquid substantially towards the third layer.

Advantageously, the play mat of the invention provides an ideal surface on which a child (e.g. a baby) and its carer can lie or sit, as it develops its motor skills To date, memory foam, as used in the second layer, has not been used in a child's play mat which is sized to accommodate not only a child, but also an adult (e.g. the child's parent or carer). The inventor has found that memory foam is surprisingly useful as a play mat, because it is soft, comfortable and warm, and, because it becomes softer with body temperature, but stays substantially firm with inanimate objects.

However, memory foam has several drawbacks, one of which is that it is highly water-absorbent. Therefore, if the child playing on the mat were to be sick or dribble, or if its nappy were to leak, the memory foam would absorb the liquid. Since, memory foam is difficult to wash, it would become unhygienic and smell. Hence, in order to protect the memory foam of the second layer, it is covered with the third layer, made of impermeable material, and so if the baby dribbles or is sick etc., the memory foam, and hence play mat of the invention, is not damaged. A second drawback of memory foam arises from its manufacturing method which uses, in addition to polyurethane, other chemicals, which are required to achieve the desired visco-elastic properties of memory foam. These chemicals give new memory foam a characteristic paint or glue-like smell. It is known that babies have a much more sensitive smell than adults, which forms an important part of the bonding process between a baby and its carer. The smell of new memory foam is therefore another undesirable property for a baby mat. In order to reduce the smell of memory foam it may be advantageous to enclose the memory foam layer between the two impermeable layers (i.e. the first and third layers), which keep the smell away from the baby.

The inventor has found, however, that the third, impermeable layer, is not entirely comfortable for the child and parent to lie on for extended periods of time. Furthermore, should the baby dribble or be sick, the liquid could pose a slipping hazard (even a baby's hand slipping away from underneath it could hurt) and/or it could run off the impermeable, third layer and damage the floor. Therefore, the fourth, upper layer is provided, which is capable of absorbing liquid, and wicking it towards the third layer, and away from the upper surface. Finally, the first layer, which is also impermeable, is provided so that the play mat can be used outdoors, for example on grass.

Preferably, when in use, the first layer is arranged to be placed adjacent a ground surface, which, because the material is impermeable, may be either indoors or outdoors. Hence, the first layer may be referred to as the base of the play mat. The first layer may be between about 0.2 mm and 5 mm thick, or between about 0.5 and 3 mm thick. The first layer is preferably waterproof, and preferably durable, so that it does not tear or become damaged when placed on the ground. The first layer should be substantially impenetrable, and ideally durable enough to withstand twigs, small stones or thistles, which may be present in the grass during outdoor use. The first layer may also comprise a non-slip material. Advantageously, because the material is non-slip, it may be used on ground surfaces which may be slippery, for example on ceramic tiles, wood, laminate flooring or on grass.

In one embodiment, the first layer may comprise latex (e.g. synthetic latex), rubber (e.g. nitrile or silicone rubber), styrenic elastomers, polyurethane or PVC. In another embodiment, the first layer may comprise a fibre covered in a plastic material, for example the material available under the trade name Goretex® (which may be available from W. L. Gore), Elvaloy® and Hypalon® (which may be available from DuPont), Dartex® fabric (which may be available from Dartex) and Permalon® (which may be available from Reef Industries). Preferably, and advantageously, the first layer is unable to trap dirt easily, and can be wiped clean with a damp cloth, thereby ensuring that the mat remains hygienic.

Preferably, when the play mat is in use, the second layer is disposed immediately above the first layer. The second layer may be attached to the first layer, preferably between inner regions thereof, for example by glue, adhesive, or by stitching. It will be appreciated that memory foam comprises polyurethane, frequently comprising additional chemicals for increasing its viscosity and/or density. It may also be referred to as low resilience polyurethane foam, and may be available from Tempur.

It will be appreciated that memory foam has an internal cell structure, and that the tighter the cell structure, the denser the material, and the less easy it is to compress, thereby providing more support for the child and parent. The density of the second layer may be at least 10 kg/m³, 20 kg/m³, 30 kg/m³, 40 kg/m³, 50 kg/m³, 60 kg/m³, 70 kg/m³, 80 kg/m³or at least 90 kg/m³. Preferably, the second layer has a density of between about 30 and 140 kg/m³, or between about 40 and 120 kg/m³. A second layer having such a density provides excellent shock absorption for a baby sitting or standing on the play mat that may then fall over. However, the second layer provides little indentation by its body weight, and so does not stop the baby from rolling about when it is lying on its tummy exercising. In addition, the second layer also provides a comfortable surface for the carer, as the child exercises and plays.

The second layer may be between about 5 mm and 70 mm thick, or between about 10 mm and 50 mm thick, or between about 15 mm and 30 mm thick. Advantageously, the memory foam of the second layer adjusts to the baby's body temperature and can help keep it warm. Hence, the mat may be placed on a ground surface which may otherwise be too cold for a baby (and its carer) to lie on.

Preferably, when in use, the third layer is disposed immediately above the second layer. The third layer may be attached to the second layer, preferably between inner regions thereof, for example by glue, adhesive, or by stitching.

The third layer is preferably waterproof. Advantageously, because the third layer is waterproof, it is capable of protecting the memory foam component of the second layer from any liquids it may come into contact with, for example dribble, vomit or spills from the baby, or drinks. Preferably, the third layer is soft, stretchable and very thin in order to convey the desired properties of the memory foam. The third layer may comprise a knitted, woven or non-woven material, which may be coated with a thin polymer membrane (e.g. polyurethane, polyethylene, polyvinyl chloride or EVA). The third layer may be between about 0.01 mm and 5 mm thick, or between about 0.2 mm and 2 mm thick.

For example, the third layer may comprise the material available under the trade name Permalon® (which may be available from Reef Industries), Suavinet® (which may be available from Bedding Industrial Beguda), Mesathane® or Mesalon® (which may be available from Mesa Laminated Fabrics), Windmaster® (which may be available from Sympatex), Kiba-Flex ® (which may be available from Kiba), Isotex® or Isowear® (which may be available from Isotex) or Dartex® (which may be available from Dartex).

The first layer and the third layer may be attached together, preferably along at least a region of a peripheral edge thereof. Preferably, the first and third layers are attached together along the entire peripheral edge thereof. Advantageously, because the first and third layers are attached to each other, a child is prevented from being accidentally trapped between them, i.e. two impermeable, waterproof and therefore airtight layers, thereby avoiding injury.

A further advantage of attaching the first and second layer together, possibly with sealed seams, is that it would contain the smell of the memory foam, which is known to release gases from chemicals used during the manufacturing process. The two layers therefore aid to contain any chemicals that are added to foam (for example, to render the foam flame-retardant) and released later, thereby avoiding the child from being exposed to unpleasant and possibly harmful chemicals.

Preferably, when in use, the fourth layer is disposed immediately above the third layer. The fourth layer may be made from different fabrics to suit varying conditions, for example silk and satin are known to feel cool, which would be useful during summer, whilst terry and brushed cotton give the fabric a warm feel, which would be more suitable for winter months.

Thus, the fourth layer may comprise knitted or woven materials. For example, suitable knitted or woven materials may include cotton, wool, silk, linen, cashmere, bamboo, nylon, rayon, satin, viscose, hemp, acetate, acrylic, or polyester etc., or any combinations of these. The fourth layer may comprise a non-woven material. For example, suitable non-woven materials may include felt, cerex, and non-woven or spun-bound polypropylene. The fourth layer is able to absorb and wick fluids (such as dribble or vomit etc.) quickly away from the child, and towards the inner waterproof layer. This wicking action of the fourth layer ensures that the baby and its carer are kept comfortable and dry, and the waterproof third layer prevents water damage to the second layer. The fourth layer is preferably soft to touch, absorbent and machine-washable, thereby providing a hygienic environment for the child. The fourth layer may be between about 0.1 mm and 3 mm thick, or between about 0.5 mm and 2 mm thick.

The fourth layer may comprise entertainment means suitable for a developing child. For example, it is known that very young babies lack colour vision and are attracted to black and white shapes, and so the fourth later may comprise black and white regions, as entertainment. Older babies, on the other hand, may be more interested in brightly coloured objects, and so the fourth layer may comprise brightly coloured regions, objects or toys, as entertainment. The print of the upper fourth layer may therefore be chosen in line with the baby's developmental stage. The fourth layer may also comprise various prints that may engage the carer or an older child, such prints including songs, nursery rhymes, stories or landscapes, roads and train tracks for older children.

Further, the fourth layer may comprise a region of self-indicating ink, such as thermochromic ink (i.e. temperature indicating) or photochromic ink (i.e. UV indicating). Thermochromic ink would alert the child's parent if the mat of the invention was getting too hot (or cold), for example in the sun. Photochromic ink would alert the parent if the mat was being exposed to excessive levels of UV.

The fourth layer is preferably attached to the rest of the play mat in order to provide a straight, smooth surface for the child and parent to play on. This is in contrast to a blanket which could easily be pulled over the baby's face, or which would create ripples which are undesirable, especially when playing.

The fourth layer may be attached to the first layer and/or the third layer, for example by glue, adhesive, or by stitching. However, preferably the fourth layer is detachable from the rest of the play mat. This allows it to be periodically washed, when it becomes dirty after use. The fourth layer may be disposable. For example, the fourth layer may be attached to the first and/or third layer by fastening means, which allows it to be detached from the rest of the play mat. The fastening means may comprise at least one zip, press stud, button, or a hook and loop system (which may be available under the trade name Velcro®) or a mushroom system (which may be available under the trade name Dual Lock®). The fastening means may be disposed along at least a region of a peripheral edge of the fourth layer and the first and/or third layer.

The play mat may be approximately at least lm by lm in dimension, or at least 1.5 by 1.5 m in dimension, or at least 1.5 m by 2 m in dimension, and so is easily large enough to accommodate at least one active baby or child, and at least one adult. The mat may be between approximately 1 cm and 6 cm thick, or between 2 cm and 4 cm thick.

In a second aspect, there is provided use of the play mat of the first aspect, for developing a child's motor skills

The play may be used for the child to play on, or for exercising on, e.g. learning how to crawl or walk. Advantageously, because the mat is large enough for an adult to sit or lie on together with the child, the child's motor skills may be improved better than in the absence of an adult, who can help support the child.

In a third aspect of the invention, there is provided a method of manufacturing a child's play mat, the method comprising the steps of:
(i) providing a first layer comprising an impermeable material;
(ii) providing a second layer comprising polyurethane memory foam, and placing the second layer adjacent the first layer;
(iii) providing a third layer comprising an impermeable material, and placing the third layer adjacent the second layer; and
(iv) providing a fourth layer comprising a material capable of absorbing liquid, and placing the fourth layer adjacent the third layer.

The method of the third aspect preferably comprises use of the various layers as described in relation to the mat of the first aspect. The method may comprise attaching the first layer and/or the third layer to the second layer, preferably by adhesive, glue or sticking. The method may comprise attaching the fourth layer to the first and/or third layer, preferably by adhesive, glue or sticking, or by fastening means.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying diagrammatic drawings, in which:—

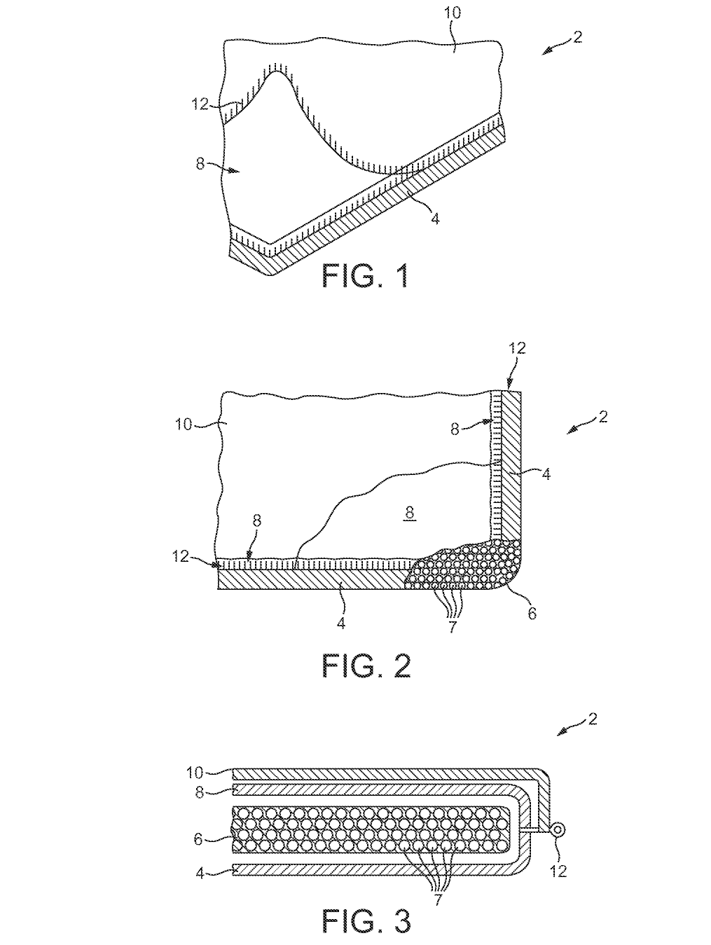

FIG. 1 is an enlarged perspective view of one embodiment of a child's play mat according to the invention;

FIG. 2 is an enlarged partial cross-sectional plan view of the play mat shown in FIG. 1; and

FIG. 3 is a schematic side view of the play mat.

### EXAMPLE

FIGS. 1, 2 and 3 show different views of an embodiment of a child's play mat 2, which is rectangular in shape and approximately 1.5 m by 2 m in dimension. In terms of its surface area, the mat 2 is large enough to accommodate at least one active baby or child, and at least one adult. The mat 2 is approximately 3 cm thick, and provides comfort and support for the child and its carer. The mat 2 therefore provides a perfect surface on which the child and its carer can lie or sit, as the baby develops its motor skills during the first few months of its life.

As shown most clearly in FIG. 3, the mat 2 consists of a laminate material comprising four distinct layers, namely a lower base layer 4, an inner foam layer 6, an inner waterproof layer 8 and an upper layer 10. In use, the base layer 4 is placed adjacent the floor surface, which can be either indoors or outdoors. The base layer 4 is about 2 mm thick and is made of a durable waterproof material. In addition, the material is non-slip, in case it is used on potentially slippery hard flooring, for example ceramic tiles, wood or laminate flooring. The base layer 4 can be made of latex (e.g. synthetic latex), nitrile or silicone rubber, styrenic elastomers, polyurethane or PVC. The material can also be a fibre covered in a plastic material, such as Goretex®, Elvaloy®, Hypalon®, Dartex®, Kiba-Flex®, Permalon®, Mesathane® or Mesalon®. Ideally, the material forming the base layer 4 is unable to trap dirt easily, and can be wiped clean with a damp cloth, if necessary.

The inner foam layer 6 is disposed adjacent the base layer 4, and so, when the mat is in use and placed on the ground, the foam layer 6 is disposed immediately above the base layer 4. The foam layer 6 is made of a polyurethane core, which is about 2.5 cm thick. A variety of polyurethane foams exist, which can be used in the mat 2 of the invention. However, in the embodiment shown in the Figures, the foam 6 is visco-elastic or “memory foam”, which is a polyurethane composition with additional chemicals, which increase its viscosity and density. Memory foam 6 has an open-cell 7 structure that reacts to body heat and weight by ‘moulding’ to one's body. Different types of memory foam 6 can be distinguished from each other by their chemical consistency (i.e. chemicals additives used in its production), as well as their cell 7 structure, which in turn dictates their density.

The tighter the cell 7 structure, the denser the foam material 6, and the less easy it is to compress, thereby providing more support. For example, foam density of about 80 kg/m³ or greater is considered to be high quality, whereas standard memory foam has a density of about 16-80 kg/m³, and so the foam core layer 6 in the mat 2 can have any of these densities. Most bedding, such as topper pads and comfort layers in mattresses, has a density of about 48 kg/m³ to 72 kg/m³. The ideal composition of the foam layer 6 of the floor mat 2 of the invention however is polyurethane having a density of between about 48 and 112 kg/m³. Such a foam 6 provides good shock absorption for a baby which is sitting or standing on the mat 2 but then falls over, while providing little indentation by its body weight, and therefore does not stop the baby from rolling about when it is lying on its tummy exercising. Moreover, the foam layer 6 also provides a comfortable platform for the carer, which is important for prolonged periods of exercise or play for the baby.

The memory foam 6 adjusts to a person's body temperature and can help keep a person warm. It therefore provides an ideal material to be placed on the floor which may otherwise be too cold for a baby (and its carer) to play or lie on. The height of the memory foam pad 6 is a compromise between giving sufficient insulation, shock absorption and comfort to the baby on the one hand, while on the other hand, avoiding the danger that the baby might injure itself should it roll off the mat 2. The ideal height for the memory foam layer 6 is about 2.5 cm, though slightly thinner or thicker memory foam layers 6 can also be used, e.g. between about 1 cm to 5 cm.

The inner waterproof layer 8 is disposed adjacent the foam layer 6, and so, in use, is provided immediately on top of the memory foam 6. Layer 8 is waterproof in order to protect the foam layer 8 from any dribble, vomit or spills from the baby. However, to make the most use of the characteristics of the memory foam layer 6, the inner waterproof layer 8 should also be soft and highly stretchable. Otherwise, the moulding properties of the memory foam 6 would be wasted. For example, the waterproof layer 8 can be made of a fibrous woven material which is coated with a thin polymer membrane (e.g. polyurethane), for example Permalon®, Suavinet ®, Dartex®, Mesathane®, Mesalon®, Windmaster®, Kiba-Flex®, Isotex® or Isowear®.

The base layer 4 and inner waterproof layer 8 are permanently attached to each other at their peripheral edges so as to prevent a child from being accidentally trapped between two waterproof (and substantially airtight) layers 4, 8. However, the inventor believes that if the memory foam layer 6 were to fold over or bunch up in one corner, it could be difficult to straighten out. Therefore, the inventor believes that this could be avoided by gluing one or both of the two waterproof layers 4, 8 to the foam layer 6.

While layer 8 provides excellent protection for the memory foam layer 6, its waterproof nature means that it is not very breathable or comfortable, and hence is unsuitable for the baby and its carer to lie directly thereon. Therefore, the upper layer 10, which is disposed adjacent the inner waterproof layer 8, is made of a soft knitted, woven or non-woven material, such as cotton, wool, or polyester etc., which is able to wick fluids (such as dribble or vomit etc.) quickly away from the baby, and towards the inner waterproof layer. This wicking action ensures that the baby and its carer are kept comfortable and dry, and the inner waterproof layer 8 prevents damage to the memory foam 6. The upper layer 10 is soft to touch, absorbent and machine-washable, and so provides a hygienic environment for the baby. The layer 10 is firmly attached to the rest of the mat 2 in order to provide a straight, smooth surface, as opposed to a blanket which could be pulled over the baby's face or create ripples which are undesirable, especially when playing.

In order to provide a convenient solution for a busy parent, the machine-washable upper layer 10 is detachable from the rest of the mat 2. It is easy to remove from the rest of the floor mat 2 by means of a reversible fastener 12, as shown in FIG. 3, such as press studs, buttons, a zip, hook and loop system (e.g. Velcro®) or mushrooms (e.g. Dual Lock®), which are provided along the peripheral edge of the either layer 4 and/or layer 8. FIG. 1 shows the mat 2 in which the reversible fastener 12, shown as a zip, has been partially undone, thereby allowing the upper layer 12 to be pulled away and detached from the rest of the mat 2.

Advantages of the play mat 2 reside in the interchangeable, taut, straight upper layer 10, which provides an ideal surface for babies and their carers to play on, for example stacking bricks or cups, or standing up small toys, etc. The memory foam layer 6 provides the most comfortable environment for the baby and carer, and the waterproof base 4 allows the floor mat 2 to be used in many environments, including indoors as well as outdoors. Because of the memory foam core 6, the floor mat 2 is relatively heavy. However, it is light enough to move around the home, including the garden, and can be transported in the car, for example when visiting a relative or friend. It is therefore both a means of keeping a baby on a suitable floor, as well as protecting the floor below. Finally, the upper layer 10 is detachable, and machine-washable, and so it can be readily removed from the rest of the mat 2 and cleaned, when necessary.

1. A child's play mat comprising:
(i) a first layer comprising an impermeable material;
(ii) a second layer disposed adjacent the first layer, and comprising polyurethane memory foam;
(iii) a third layer disposed adjacent the second layer, and comprising an impermeable material; and
(iv) a fourth layer disposed adjacent the third layer, and comprising a material capable of absorbing liquid, and wicking the liquid substantially towards the third layer.

2. A play mat according to claim 1, wherein the first layer is waterproof and durable, so that it does not tear or become damaged when placed on the ground, wherein the first layer comprises latex (e.g. synthetic latex), rubber (e.g. nitrile or silicone rubber), styrenic elastomers, polyurethane, PVC, Goretex®, Elvaloy®, Hypalon®, Dartex® or Permalon®.

3. A play mat according to claim 1, wherein the density of the second layer is at least 10 kg/m³, 20 kg/m³, 30 kg/m³, 40 kg/m³, 50 kg/m³, 60 kg/m³, 70 kg/m³, 80 kg/m³ or at least 90 kg/m³.

4. A play mat according to claim 1, wherein the second layer is between 5 mm and 70 mm thick, or between about 10 mm and 50 mm thick, or between about 15 mm and 30 mm thick.

5. A play mat according to claim 1, wherein the third layer is soft, stretchable, and waterproof.

6. A play mat according to claim 1, wherein the third layer comprises a knitted, woven or non-woven material, and wherein the third layer is coated with a thin polymer membrane (e.g. polyurethane, polyethylene, polyvinyl chloride or EVA).

7. A play mat according to claim 1, wherein the third layer comprises the material available under the trade name Permalon®, Suavinet®, Mesathane®, Mesalon®, Windmaster®, Kiba-Flex ®, Isotex®, Isowear® or Dartex®.

8. A play mat according to claim 1, wherein the first layer and the third layer are attached together, preferably along at least a region of a peripheral edge, optionally along the entire peripheral edge thereof.

9. A play mat according to claim 1, wherein the fourth layer comprises knitted or woven material, for example cotton, wool, silk, linen, cashmere, bamboo, nylon, rayon, satin, viscose, hemp, acetate, acrylic, or polyester etc., or any combinations of these.

10. A play mat according to claim 1, wherein the fourth layer comprises non-woven material, for example felt, cerex and non-woven or spun-bound polypropylene.

11. A play mat according to claim 1, wherein the fourth layer comprises a region of self-indicating ink, such as thermochromic ink (i.e. temperature indicating) or photochromic ink (i.e. UV indicating).

12. A play mat according to claim 1, wherein the fourth layer is attached to the first layer and/or the third layer.

13. A play mat according to claim 1, wherein the fourth layer is attached to the first layer and the third layer.

14. A play mat according to claim 1, wherein the fourth layer is detachable from the rest of the play mat.

15. A play mat according to claim 1, wherein the fourth layer is attached to the first and/or third layer by fastening means, which allows it to be detached from the rest of the play mat.

16. A play mat according to claim 15, wherein the fastening means comprises at least one zip, press stud, button, or a hook and loop system (available under the trade name Velcro®) or a mushroom system (available under the trade name Dual Lock®), optionally wherein the fastening means is disposed along at least a region of a peripheral edge of the fourth layer and the first and/or third layer.

17. Use of the play mat according to claim 1, for developing a child's motor skills, for example for playing or exercising on.

18. A method of manufacturing a child's play mat, the method comprising the steps of:
(i) providing a first layer comprising an impermeable material;
(ii) providing a second layer comprising memory foam, and placing the second layer adjacent the first layer;
(iii) providing a third layer comprising an impermeable material, and placing the third layer adjacent the second layer; and
(iv) providing a fourth layer comprising a material capable of absorbing liquid, and placing the fourth layer adjacent the third layer.

19. A method according to claim 18, wherein the method comprises attaching the fourth layer to the first and/or third layer, preferably by fastening means.

20. A method according to claim 19, wherein the fastening means is as defined in claim 16.
